(19) United States
(12) Patent Application Publication
(10) Pub. No.: US 2017/0016984 A1
(43) Pub. Date: Jan. 19, 2017

(54) Device for Measuring Surface Speed and Liquid Level of Fluid

(71) Applicant: U&U ENGINEERING INC., TAIPEI CITY (TW)

(72) Inventors: Hung-Chun LIN, Taipei City (TW); Shou-Cheng CHANG, Taipei City (TW); Ping-Chang TSAO, Taipei City (TW); Shang-Fong CHIU, Taipei City (TW); Chi-Ho CHANG, Taipei City (TW)

(21) Appl. No.: 14/828,635

(22) Filed: Aug. 18, 2015

(30) Foreign Application Priority Data
Jul. 14, 2015 (TW) 104122804

(51) Int. Cl. G01S 13/58; G01F 23/284; G01F 1/00

(52) U.S. Cl. CPC G01S 13/584; G01F 1/00; G01F 23/284

(57) ABSTRACT

A device for measuring a surface speed and a liquid level of a fluid is disclosed. The device includes a RF transceiving module for alternatively transmitting a first FMCW signal and a first CW signal to the fluid, and receiving a second FMCW signal and a second CW signal reflected from the fluid. A processor is used for calculating the liquid level of the fluid based on a frequency difference between the first FMCW signal and the second FMCW signal, and for calculating the surface speed of the fluid based on a frequency difference between the first CW signal and the second CW signal. Since the device integrates functions of measuring the surface speed and the liquid level of a fluid, it reduces an occupied room and facilitates a synchronization of data transmission.

### BACKGROUND OF THE INVENTION

1. Field of the Invention

The present invention relates to a device for automatic measurement, and more particularly, to a device with integration of a flow meter and a level gauge of the river.

2. Description of the Prior Art

It is common to install a flow meter and a level gauge on bridges to automatically monitor the surface speed and the water level of rivers. The flow meter is used for detecting the surface speed of a fluid such flows of a river or a brook. The amount of the river or brook can be determined in a period of time after the surface speed is detected. It facilitates to determine if any damages may happen in the downstream area or if water in downstream reservoirs may be discharged. The flow meter measures the surface speed of a fluid with microwave or sound wave based on the Doppler Effect. The level gauge calculates the distance between the level gauge itself and the surface based on microwave or sound wave (ultrasonic wave). Conventionally, the flow meter and the level gauge are installed on the same support to form a measurement system. The support is fixed under the bridge. Flow meter, level gauge, signal processors, and data storage devices are fixed on the surface of the support. The signal processors and the data storage devices send signal during a set period of time to notify all of the flow meter and the level gauge of sending the data of the measured surface speed and water level of the fluid to the signal processors for further analyses.

However, it is required to install an independent flow meter, a level gauge, a signal processor, and a data storage device in the conventional measure system, which occupies room of the conventional measure system. It is often restricted to space and choices of location when the conventional measure system is installed. Except the restrictions of quantity and installation, problems such as signal integration and synchronization of time sequence also occur in the conventional measure system. Such problems often cause time sequence of information concerning water flows and water levels to be ahead of schedule or to be behind schedule.

In addition, the flow meter and the level gauge are independent in dealing the data with integration of no circuit as hardware. So each flow meter and each level gauge adopts different interfaces (such as RS-232 or RS-485) for gathering signals, which greatly reduces the processing speed of the whole measure system. Plus, because of asynchronous time sequence, the correlation and dependability of the data measured by the whole measure system cannot be accurately evaluated.

### SUMMARY OF THE INVENTION

Therefore, an object of the present invention is to provide a device integrating functions of radio frequency (RF) transceiving modules of a flow meter and a level gauge to be a single RF transceiving module. An intermediate frequency (IF) circuit with different filter segments is designed in the device for separating information of distance and speed of water flows and water levels. The device with integration of the flow meter and the level gauge is used for solving the problem occurring in the conventional technology.

According to the present invention, a device for measuring a surface speed and a water level of a fluid is provided. The device comprises a radio frequency transceiving module, an intermediate frequency module, a processor, and a phase locked loop. The radio frequency transceiving module is used for alternatively transmitting a first frequency modulation continuous wave signal and a first continuous wave signal to the fluid and for receiving a second frequency modulation continuous wave signal and a second continuous wave signal reflected by the fluid. The intermediate frequency module electrically connected to the radio frequency transceiving module, is used for filtering the second frequency modulation continuous wave signal and the second continuous wave signal. The processor electrically connected to the intermediate frequency module, is used for calculating the water level of the fluid based on a frequency difference between the first frequency modulation continuous wave signal and the second frequency modulation continuous wave signal, a frequency scanning time, and a scanning bandwidth of the first frequency modulation continuous wave signal, for calculating the surface speed of the fluid based on a frequency difference between the first continuous wave signal and the second continuous wave signal and the frequency of the continuous wave signal, and for generating a timing control signal. The phase locked loop electrically connected to the radio frequency transceiving module and the processor, is used for outputting the first frequency modulation continuous wave signal and the first continuous wave signal according to the timing control signal.

In one aspect of the present invention, the timing control signal comprises a triangular pulse and a square pulse in alternations.

In another aspect of the present invention, the phase locked loop comprises a frequency synthesizer, a loop filter, a voltage controlled oscillator, and a first power divider. The frequency synthesizer electrically connected to the processor, is used for generating a first phase difference signal according to the square pulse of the timing control signal and the first continuous wave signal, and for generating a second phase difference signal according to the triangular pulse of the timing control signal. The loop filter electrically connected to the frequency synthesizer, is used for filtering the first phase difference signal and the second phase difference signal. The voltage controlled oscillator, electrically connected to the loop filter, is used for generating the first continuous wave signal according to the filtered first phase difference signal, and for generating the first frequency modulation continuous wave signal according to the filtered second phase difference signal. The first power divider electrically connected to the voltage controlled oscillator and the frequency synthesizer, is used for outputting the first continuous wave signal and the first frequency modulation continuous wave signal, and for feed-backing the first continuous wave signal and the first frequency modulation continuous wave signal to the frequency synthesizer.

In another aspect of the present invention, the radio frequency transceiving module comprises: a coupler for filtering the first continuous wave signal, a bandpass filter electrically connected to the coupler, a first transmitting antenna electrically connected to the bandpass filter for transmitting the first continuous wave signal, a first receiving antenna for receiving the second continuous wave signal, a second transceiving antenna for transmitting the first frequency modulation continuous wave signal and receiving the second frequency modulation continuous wave signal, a second power divider electrically connected to the coupler, a third power divider electrically connected to the first receiving antenna, a circulator electrically connected to the second power divider, the second transceiving antenna, and the third power divider, for filtering the first frequency modulation continuous wave signal to the second transceiving antenna and for filtering the second frequency modulation continuous wave signal to the third power divider, and a frequency mixer electrically connected to the second power divider and the third power divider.

In another aspect of the present invention, the device further comprises a frequency multiplier and a power amplifier, electrically connected to the frequency multiplier. The frequency multiplier is electrically connected to the first power divider, and is used for boosting the frequency of the first continuous wave signal and the frequency of the first frequency modulation continuous wave signal.

In still another aspect of the present invention, the device further comprises a level gauge, for detecting a vertical angle of elevation and an included angle of water flows of the device.

In yet another aspect of the present invention, the processor is used for calculating the surface speed of the fluid based on a frequency difference between the frequency of the first continuous wave signal and the frequency of the second continuous wave signal, the frequency of the first continuous wave signal, the included angle of water flows, and the vertical angle of elevation.

Compared with the prior art, the device proposed by the present invention integrates the flow meter and the level gauge. The device reduces an occupied room, integrates time sequence of measurement of water flows and water levels, and facilitates a synchronization of data transmission. The device itself can measure water flows and water levels at the same time.

These and other features, aspects and advantages of the present disclosure will become understood with reference to the following description, appended claims and accompanying figures.

### BRIEF DESCRIPTION OF THE DRAWINGS

FIG. 1 is a schematic diagram of a measuring device installed on a bridge according to an embodiment of the present invention.

FIG. 2 is a functional block diagram of the measuring device as shown in FIG. 1.

FIG. 3 is sequence diagram of the timing control signal generated by the processor.

FIG. 4 is a schematic diagram of calculating the liquid level according to the FMCW signals.

FIG. 5 is a schematic diagram of calculating the surface speed of the fluid according to the CW signals.

### DETAILED DESCRIPTION OF THE PREFERRED EMBODIMENTS

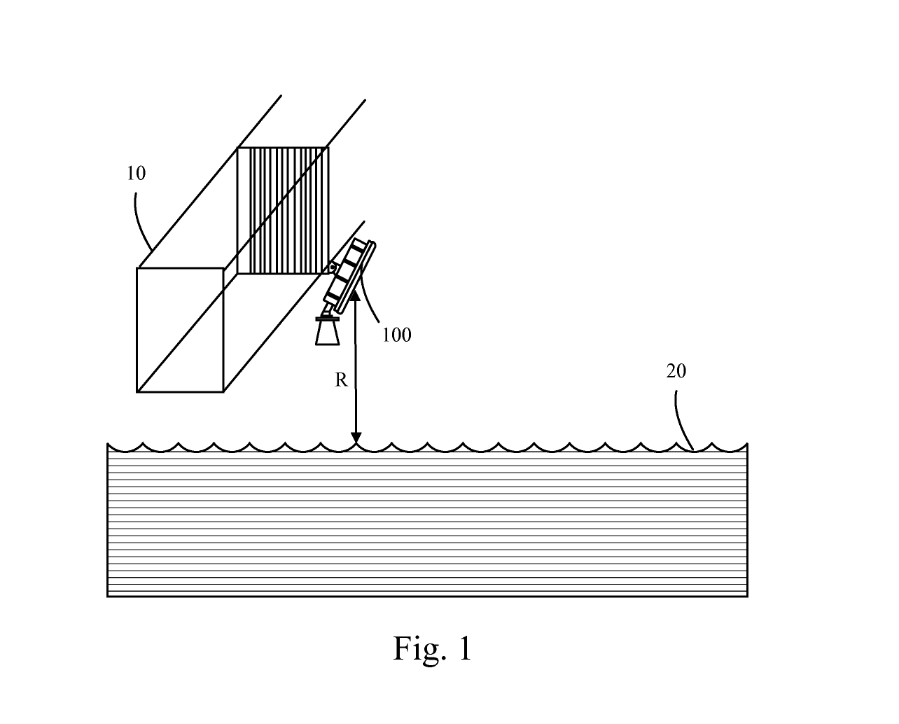

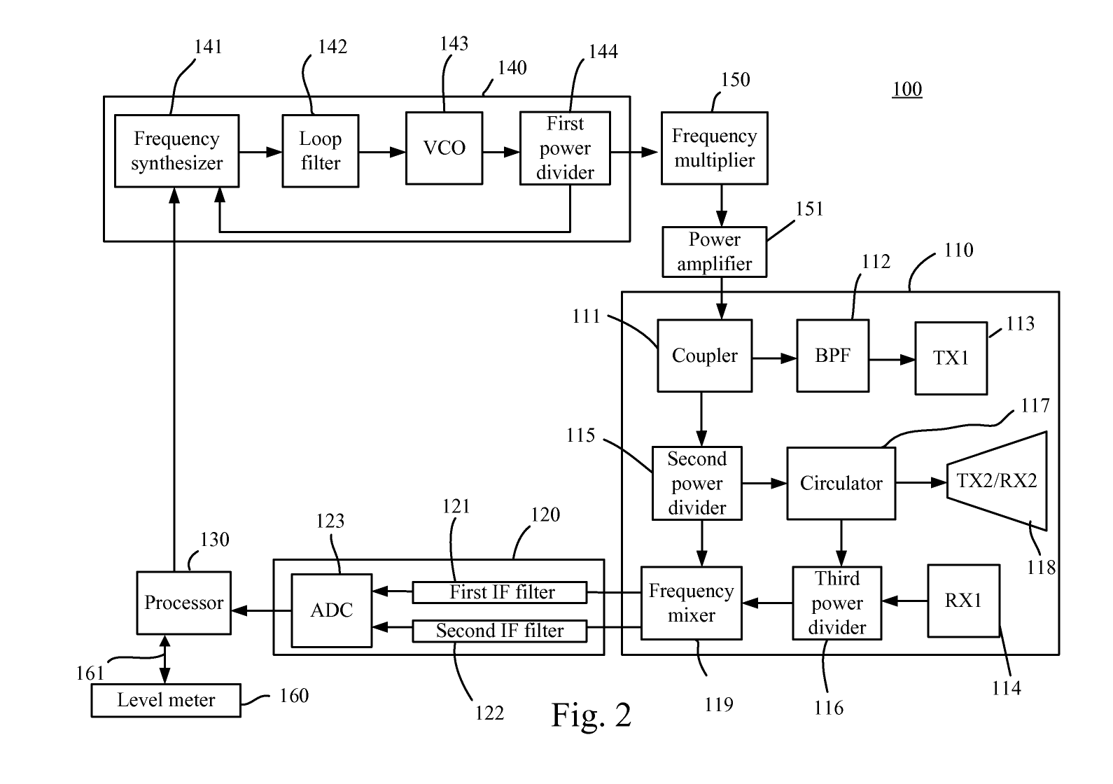

Please refer to FIG. 1 and FIG. 2. FIG. 1 is a schematic diagram of a measuring device 100 installed on a bridge 10 according to an embodiment of the present invention. FIG. 2 is a functional block diagram of the measuring device 100. The measuring device 100 is installed above a fluid 20 for measuring a surface speed and a water level of the fluid 20. Typically, the measuring device 100 can be disposed on the bridge 10 stretching over the fluid 20 (such as a river).

Please refer to FIG. 2. FIG. 2 is a functional block diagram of the measuring device 100. The measuring device 100 comprises a RF transceiving module 110, an IF module 120, a processor 130, a phase locked loop 140, a frequency multiplier 150, and a power amplifier 151. The RF transceiving module 110 is used for alternatively transmitting a first frequency modulation continuous wave (FMCW) signal and a first continuous wave (CW) signal to the fluid 20 and for receiving a second FMCW signal and a second CW signal reflected by the fluid 20. The IF module 120 is electrically connected to the RF transceiving module 110 and is used for filtering the second FMCW signal and the second CW signal. The processor 130 is electrically connected to the IF module 120 and is used for calculating the liquid level of the fluid based on a frequency difference between the first FMCW signal and the second FMCW signal, a frequency scanning time, and a scanning bandwidth of the first FMCW signal. The processor 130 is also used for calculating the surface speed of the fluid based on a frequency difference between the first CW signal and the second CW signal and the frequencies of the first and second CW signals. The phase locked loop 140 is electrically connected to the RF transceiving module 110 and the processor 130 and is used for outputting the first FMCW signal and the first CW signal according to a timing control signal S_{CON}.

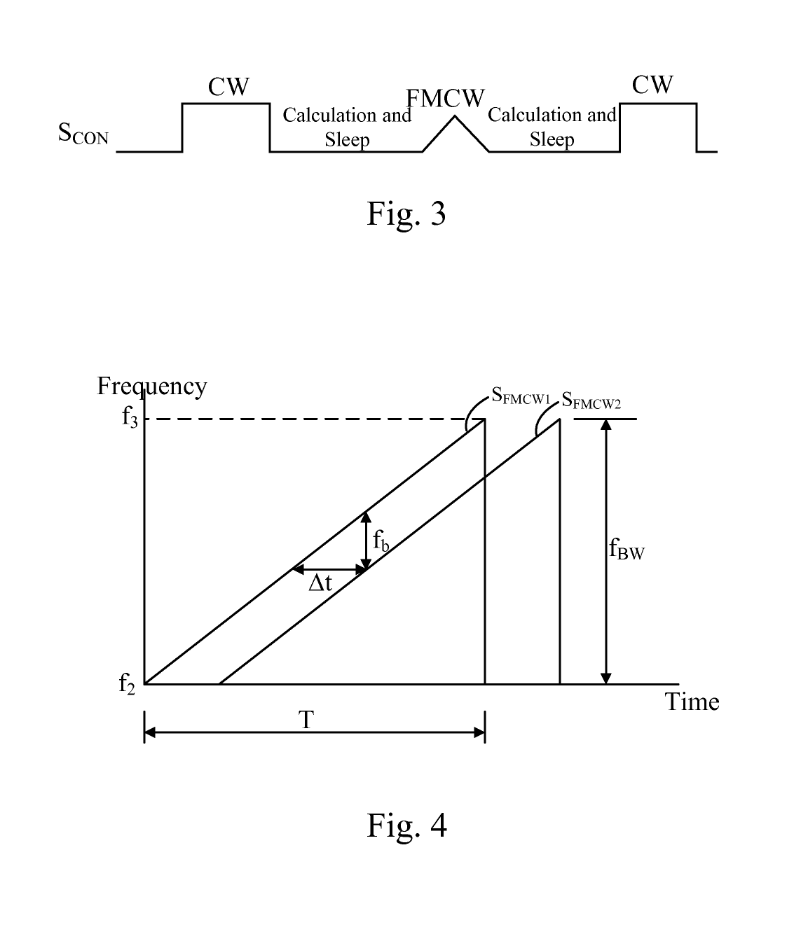

Please refer to FIG. 2 and FIG. 3. FIG. 3 is sequence diagram of the timing control signal S_{CON} generated by the processor 130. To enable the RF transceiving module 110 to transmit the first FMCW signal and the first CW signal alternatively, the timing control signal S_{CON} emitted by the processor 130 comprises a triangular pulse and a square pulse in alternations. The timing control signal S_{CON} is transmitted to the phase locked loop 140.

Preferably, the design of the VCO 143, all active and passive components, and a microstrip is developed in one half or one fourth of a RF operating frequency. Next, the VCO 143 is electrically connected to the frequency multiplier 150 of the first power divider 144. The frequency of the first CW signal S_{CW1} and the frequency of the first FMCW signal S_{FMCW1} output by the phase locked loop 140 increase twice or quadruple to fulfill the RF operating frequency. Afterwards, the power amplifier 151 further amplifies the first CW signal S_{CW1} and the first FMCW signal S_{FMCW1}. When the VCO 143, all of the active and passive components, and the microstrip are designed, their frequencies are planned to be lower, so a loss on a microstrip signal is prevented, and costs on high-frequency components are lowered. Before the first CW signal S_{CW1} and the first FMCW signal S_{FMCW1} are transmitted to the RF transceiving module 110, the frequency of the first CW signal S_{CW1} and the frequency of the first FMCW signal S_{FMCW1} are enhanced to the RF operating frequency.

The RF transceiving module 110 comprises a coupler 111, a bandpass filter 112, a first transmitting antenna 113, a first receiving antenna 114, a second power divider 115, a third power divider 116, a circulator 117, a second transceiving antenna 118, and a frequency mixer 119. The coupler 111 is electrically connected to the power amplifier 151 and used for filtering the first CW signal S_{CW1}. The bandpass filter 112 is electrically connected to the coupler 111 and used for filtering out noise from the first CW signal S_{CW1}. The first transmitting antenna 113 is electrically connected to the bandpass filter 112 and used for transmitting the first CW signal S_{CW1} to the fluid 20. The first receiving antenna 114 is used for receiving the second CW signal S_{CW2} reflected by the fluid 20. The second transceiving antenna 118 is used for transmitting the first FMCW signal S_{FMCW1} and receiving the second FMCW signal S_{FMCW2} reflected by the fluid 20. The second power divider 115 is electrically connected to the coupler 111. The third power divider 116 is electrically connected to the first receiving antenna 114. The circulator 117 is electrically connected to the second power divider 115, the second transceiving antenna 118, and the third power divider 116. The circulator 117 is used for filtering the first FMCW signal S_{FMCW1} to the second transceiving antenna 118 and filtering the second FMCW signal S_{FMCW2} to the third power divider 116. The frequency mixer 119 is electrically connected to the second power divider 115 and the third power divider 116 and used for mixing the first FMCW signal S_{FMCW1} with the second FMCW signal S_{FMCW2} or mixing the first CW signal S_{CW1} with the second CW signal S_{CW2}.

The processor 130 calculates the liquid level of the fluid 20 according to the first FMCW signal S_{FMCW1} and the second FMCW signal S_{FMCW2} and the surface speed of the fluid 20 according to the first CW signal S_{CW1} and the second CW signal S_{CW2}. The IF module 120 can comprise two IF filters 121 and 122 for preventing the processor 130 from making wrong judgment. The two IF filters 121 and 122 are used for filtering FMCW signals S_{FMCW1} and S_{FMCW2} with different band segments (from the band segment f₂ to the band segment f₃) and CW signals S_{CW1} and S_{CW2} (the band segment f₁). The IF module 120 further comprises an analog-to-digital converter (ADC) 123. The ADC 123 is used for converting the FMCW signals S_{FMCW1} and S_{FMCW2} and the CW signals S_{CW1} and S_{CW2} into digital signals.

Please refer to FIG. 3 and FIG. 4. FIG. 4 is a schematic diagram of calculating the liquid level according to the FMCW signals. When the measuring device 100 transmits the first FMCW signal S_{FMCW1}, the processor 130 will calculate the water level of the fluid 20. A distance R is between the measuring device 100 and the water surface of the fluid 20, so there is a time difference Δt between the time when the first FMCW signal S_{FMCW1} is transmitted to the fluid 20 and the time when the second FMCW signal S_{FMCW2} is received and reflected by the fluid 20. Thus, the processor 130 can obtain the distance R based on Equation (1) as follows:

R=c×Δt/2=(c×T×f_{b})/(2×f _{BW}), (1)

where c represents the speed of light; f_{b} represents the frequency difference between the first FMCW signal S_{FMCW1} and the second FMCW signal S_{FMCW2}; T represents the frequency scanning time; f_{BW} represents the scanning bandwidth of the first FMCW signal S_{FMCW1} (that is, f2-f3). After the calculation based on the equation, the processor 130 can obtain the liquid level of the fluid 20.

On the other hand, after the measuring device 100 transmits the first CW signal S_{CW1}, the fluid 20 will reflect the second CW signal S_{CW2}. Because of the Doppler effect, the frequency of the second CW signal S_{CW2} received by the measuring device 100 and the frequency of the first CW signal S_{CW1} transmitted by the measuring device 100 are different based on different surface speeds of the fluid 20. The processor 130 calculates the surface speed of the fluid 20 based on the frequency difference between the frequency of the first CW signal S_{CW1} and the frequency of the second CW signal S_{CW2} (that is, the Doppler shift f_{d}).

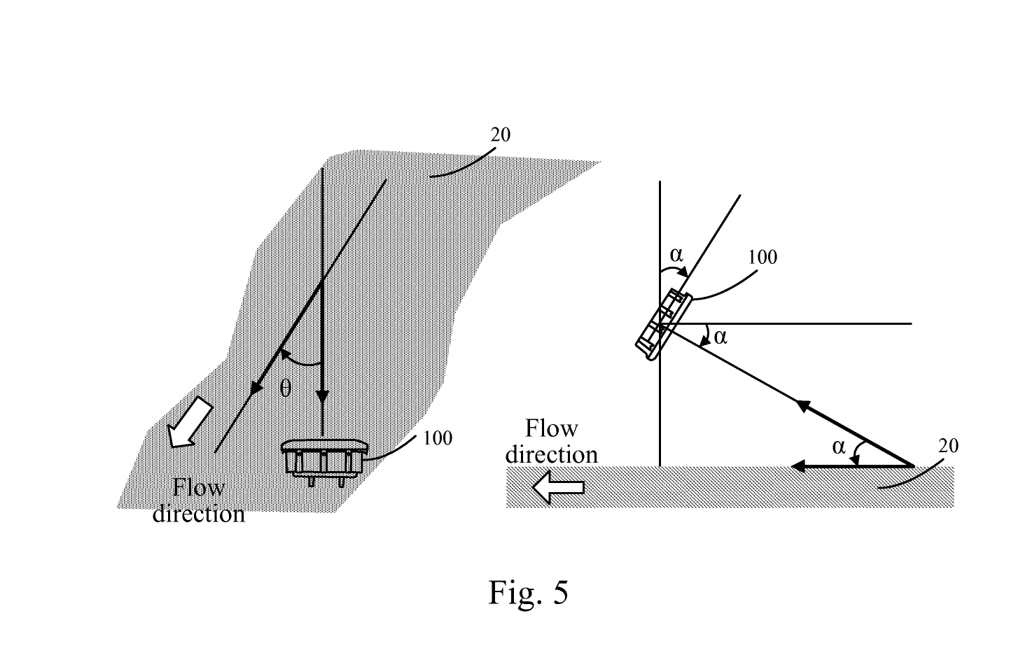

Please refer to FIG. 2 and FIG. 5. FIG. 5 is a schematic diagram of calculating the surface speed of the fluid according to the CW signals. Since the measuring device 100 may not be installed in a totally horizontal state, deviations may occur when the measuring device 100 calculates the Doppler shift. Further, the result of the surface speed of the fluid calculated by the measuring device 100 may be affected. Therefore, the measuring device 100 further comprises a level meter 160. The level meter 160 is used for detecting a vertical angle of elevation a and an included angle of streams θ of the measuring device 100. The level meter 160 is electrically connected to the processor 130 via an interface 161 of RS-232/422 and Transmission Control Protocol/IP-Internet Protocol (TCP/IP). The vertical angle of elevation α detected by the level meter 160 is output by the level meter 160 itself to the processor 130 via the interface 161. Then the processor 130 reads the vertical angle of elevation α and calculates the surface speed of the fluid accurately based on the vertical angle of elevation α and the Doppler shift f_{d}. The measuring device 100 calculates the accurate surface speed of the fluid again based on Equation (2) as follows:

V Cos(α)·cos(θ)=(f_{d·C})/(2·f₁) (2)

where V represents the surface speed of the fluid; f_{d} represents the Doppler shift; C represents the speed of light; f₁ represents the frequency of the first CW signal S_{CW1}. The included angle of streams θ of the measuring device 100 and the fluid 20 can be fixed when the measuring device 100 is installed. The vertical angle of elevation a can be adjusted with seasonal variations of the water level. The level meter 160 reads the adjusted variations of the water level and sends the data to the processor 130 so as to calculate the speed of the fluid 20. In this way, the processor 130 can calculate the surface speed of the fluid 20 according to the frequency difference between the frequency of the first CW signal S_{CW1} and the frequency of the second CW signal S_{CW2} (that is, the Doppler shift f_{d}), the frequency f₁ of the frequency of the first CW signal S_{CW1}, and the included angle of streams θ and the vertical angle of elevation α of the measuring device 100 and the fluid 20.

Compared with the conventional technology, the size of the measuring device proposed by the present invention is smaller since the measuring device integrates functions of measuring the water level of a fluid and the surface speed of a fluid. It reduces the quantity of the measuring device, simplifies communication interface, and further simplifies and speeds up steps of installing the measuring device. In addition, the measuring device comprises the frequency multiplier. With the frequency multiplier, most of the components work in the environment with a lower frequency, which reduces not only costs but also a waste on the entire microstrip. Moreover, the measuring device comprises the phase locked loop. Furthermore, with the phase locked loop, the measuring device accurately controls the range of the frequency. The measuring device controls the CW signals with a single frequency to measure the surface speed of the fluid according to the timing control signal generated by the processor. Also, the measuring device measures the water level according to the FMCW signals. That's why the measuring device can measure the surface speed and the water level at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device, for measuring a surface speed and a water level of a fluid, comprising:
a radio frequency transceiving module, for alternatively transmitting a first frequency modulation continuous wave signal and a first continuous wave signal to the fluid and for receiving a second frequency modulation continuous wave signal and a second continuous wave signal reflected by the fluid;
an intermediate frequency module, electrically connected to the radio frequency transceiving module, for filtering the second frequency modulation continuous wave signal and the second continuous wave signal;
a processor, electrically connected to the intermediate frequency module, for calculating the water level of the fluid based on a frequency difference between the first frequency modulation continuous wave signal and the second frequency modulation continuous wave signal, a frequency scanning time, and a scanning bandwidth of the first frequency modulation continuous wave signal, for calculating the surface speed of the fluid based on a frequency difference between the first continuous wave signal and the second continuous wave signal and the frequency of the continuous wave signal, and for generating a timing control signal; and
a phase locked loop, electrically connected to the radio frequency transceiving module and the processor, for outputting the first frequency modulation continuous wave signal and the first continuous wave signal according to the timing control signal.

2. The device of claim 1, wherein the timing control signal comprises a triangular pulse and a square pulse in alternations.

3. The device of claim 2, wherein the phase locked loop comprises:
a frequency synthesizer, electrically connected to the processor, for generating a first phase difference signal according to the square pulse of the timing control signal and the first continuous wave signal, and for generating a second phase difference signal according to the triangular pulse of the timing control signal;
a loop filter, electrically connected to the frequency synthesizer, for filtering the first phase difference signal and the second phase difference signal;
a voltage controlled oscillator, electrically connected to the loop filter, for generating the first continuous wave signal according to the filtered first phase difference signal, and for generating the first frequency modulation continuous wave signal according to the filtered second phase difference signal; and
a first power divider, electrically connected to the voltage controlled oscillator and the frequency synthesizer, for outputting the first continuous wave signal and the first frequency modulation continuous wave signal, and for feed-backing the first continuous wave signal and the first frequency modulation continuous wave signal to the frequency synthesizer.

4. The device of claim 3, wherein the radio frequency transceiving module comprises:
a coupler, for filtering the first continuous wave signal;
a bandpass filter, electrically connected to the coupler;
a first transmitting antenna, electrically connected to the bandpass filter, for transmitting the first continuous wave signal;
a first receiving antenna, for receiving the second continuous wave signal;
a second transceiving antenna, for transmitting the first frequency modulation continuous wave signal and receiving the second frequency modulation continuous wave signal;
a second power divider, electrically connected to the coupler;
a third power divider, electrically connected to the first receiving antenna;
a circulator, electrically connected to the second power divider, the second transceiving antenna, and the third power divider, for filtering the first frequency modulation continuous wave signal to the second transceiving antenna and for filtering the second frequency modulation continuous wave signal to the third power divider; and
a frequency mixer, electrically connected to the second power divider and the third power divider.

5. The device of claim 3, wherein the device further comprises:
a frequency multiplier, electrically connected to the first power divider, for boosting the frequency of the first continuous wave signal and the frequency of the first frequency modulation continuous wave signal; and
a power amplifier, electrically connected to the frequency multiplier.

6. The device of claim 1, wherein the device further comprises a level meter, for detecting a vertical angle of elevation and an included angle of water flows of the device.

7. The device of claim 6, wherein the processor is used for calculating the surface speed of the fluid based on a frequency difference between the frequency of the first continuous wave signal and the frequency of the second continuous wave signal, the frequency of the first continuous wave signal, the included angle of water flows, and the vertical angle of elevation.
